(19) United States
(12) Patent Application Publication
(10) Pub. No.: US 2009/0305694 A1
(43) Pub. Date: Dec. 10, 2009

(54) AUDIO-VIDEO SHARING SYSTEM AND AUDIO-VIDEO SHARING METHOD THEREOF

(76) Inventors: Yong-Ping ZHENG, Shanghai City (CN); Alex CHENG, Shanghai City (CN)

Correspondence Address: BIRCH STEWART KOLASCH & BIRCH, PO BOX 747, FALLS CHURCH, VA, 22040-0747, US

(21) Appl. No.: 12/479,222

(22) Filed: Jun. 5, 2009

(30) Foreign Application Priority Data
Jun. 6, 2008 (TW) 097121093

(51) Int. Cl. H04W 4/00; G06F 15/16

(52) U.S. Cl. 455/426.1; 709/231; 709/204

(57) ABSTRACT

An audio-video sharing method and a corresponding audio-video sharing system are disclosed. The audio-video sharing system includes a short-range wireless network, a first mobile communication apparatus storing audio-video data, and a second mobile communication apparatus. The audio-video sharing method includes the following steps. At first, the first mobile communication apparatus reads the audio-video data. The first mobile communication apparatus then multiplexes the audio-video data into a media stream by a peer-to-peer streaming protocol. Then, the first mobile communication apparatus transmits the media stream through the short-range wireless network. Then, the second mobile communication apparatus receives the media stream. Then, the second mobile communication apparatus de-multiplexes the media stream into audio-video data by the peer-to-peer streaming protocol. At last, the second mobile communication apparatus plays the audio-video data.

### BACKGROUND OF THE INVENTION

1. Field of the Invention

The invention relates to an audio-video sharing method and particularly relates to an audio-video sharing method for a mobile communication apparatus.

2. Description of the Prior Art

Along with the advance of hardware of a cell phone, the cell phone is capable of executing more multimedia functions. So, users can take a picture, listen to music, or watch videos by the cell phone. Namely, users can use cell phones to communicate with others by sounds and/or messages. Compared with the sound transmission, the required bandwidth for transmitting video is much larger. It is thus for video communication to require larger network bandwidth. Since the mobile communication network of the cell phone has transformed from 2G network to 3G network, and is moving to 4G network in the future, the bandwidth of the mobile communication network is getting larger to support video stream. Currently, users can use video communication function via a 3G cell phone, so a user at one place can see the image and hear the sound of another user at another place by the video communication function of the 3G cell phone. In other words, the video communication is similar to a video conference. Because a general 3G cell phone has a video camera, dynamic images of the user can be captured by the video camera and transmitted to the other user through the 3G network, and the screen of the cell phone of the other user can show the dynamic images of the user as well.

Please refer to FIG. 1. FIG. 1 illustrates a schematic diagram of an audio-video sharing system 1 according to prior art. Traditionally, when a transmitting cell phone 12 needs to transmits data to a receiving cell phone 14, the transmitting cell phone 12 actually transmits data to a relay base-station 16 through a 3G network, and then the relay base-station 16 transmits the data to the receiving cell phone 14. Therefore, the system supplier for supplying the 3G network can charge according to the size of the transmitted file or the time serviced by the 3G network. Presently, the charge of the data transmission and video communication on the 3G network is much higher than the charge of a general audio communication. If the distance between the transmitting cell phone 12 and the receiving cell phone 14 is not far (for example, both cell phones are in the same room), the cost of the data transmission on the 3G network is too high compared with other solution.

Besides, if the audio-video data is transmitted among the cell phones through IP network, a problem of frame delay usually occurs. Because of the transmission character of IP network, if a packet error or packet loss occurs during the transmission procedure of the audio-video data, the packet needs to be retransmitted so as to cause high latency problem. This high latency situation can not be accepted in the application of the two-way video communication.

Further, when a user makes an audio call, the user can share multimedia data such as a picture and a video by the video sharing technique of IP multimedia subsystem (IMS). In other words, the goal of multimedia data sharing can be achieved by the session initiation protocol (SIP) on the IP network. However, this video sharing technique needs a server, and the server is used for supporting user register, redirecting data, and being a proxy server. This video sharing technique can not work without the supporting of the server.

Compared with IP network, the 3G network is a kind of circuit switching network and has a characteristic of time division multiplex (TDM). Because the circuit switching network does not has the characteristic of routing between two relay points, the circuit switching network has an advantage of low latency. Therefore, high bandwidth requirement and low latency tolerance application such as video communication and real-time video sharing can work well in the circuit switching network. But, the communication cost of the 3G network is too high and is not suitable for sharing the audio-video data in a short-range.

When the cell phone plays the audio-video data such as video clips shot by the cell phone, it can not be simultaneously watched by several people because of the small screen of the cell phone. The user only can copy the video clip to his cell phone by exchanging a memory card to watch the video clip. This method of exchanging the memory card is not convenient and can not achieve the goal of simultaneously watching the same video clip. Besides, IP network has a problem of high latency, and the 3G network has a problem of high transmission charge. Both solutions can not satisfy the goal of simultaneously watching the same audio-video data and low cost.

Accordingly, the invention provides an audio-video sharing system and an audio-video sharing method to achieve the goal of real-time sharing the audio-video data to solve the aforesaid problems.

### SUMMARY OF THE INVENTION

An object of the invention is to provide an audio-video sharing method, and the goal of peer-to-peer (p2p) and synchronously playing audio-video data can be achieved by a peer-to-peer streaming protocol and a short-range wireless network. Further, the audio-video data can be shared among several mobile communication apparatuses.

According to an embodiment, the audio-video sharing system includes a first mobile communication apparatus and a second mobile communication apparatus. The first mobile communication apparatus stores audio-video data. The audio-video sharing method includes the following steps.

At first, reading the audio-video data by the first mobile communication apparatus is performed in step (a).

Afterwards, multiplexing the audio-video data into a media stream by the first mobile communication apparatus according to a peer-to-peer streaming protocol is performed in step (b).

Then, transmitting the media stream through the short-range wireless network by the first mobile communication apparatus is performed in step (c).

Then, receiving the media stream by the second mobile communication apparatus is performed in step (d).

Then, de-multiplexing the media stream into audio-video data by the second mobile communication apparatus according to the peer-to-peer streaming protocol is performed in step (e).

At last, playing the de-multiplexed audio-video data by the second mobile communication apparatus is performed in step (f).

In this embodiment, the peer-to-peer streaming protocol is 3G-324M protocol. The short-range wireless network is a wireless fidelity (Wi-Fi) network, a Bluetooth network, or an ultra wide band (UWB) network.

In this embodiment, the step (b) includes the following steps. At first, separating the audio-video data into video data and audio data by the first mobile communication apparatus is performed in step (b1). Afterwards, multiplexing the video data and the audio data into the media stream by the first mobile communication apparatus according to the peer-to-peer streaming protocol is performed in step (b2).

After performing the aforesaid steps (b1) and (b2), in the step (e), the second mobile communication apparatus de-multiplexes the media stream into video data and audio data of the audio-video data. Besides, in the step (f), the second mobile communication apparatus synchronously plays the de-multiplexed video data and audio data.

Another object of the invention is to provide an audio-video sharing system, and the goal of peer-to-peer and synchronously playing audio-video data can be achieved by a peer-to-peer streaming protocol and a short-range wireless network. Further, the audio-video data can be shared among several mobile communication apparatuses.

According to an embodiment, the audio-video sharing system of the invention includes a short-range wireless network, a first mobile communication, and a second mobile communication apparatus. The first mobile communication apparatus includes a first processor, a storage medium on which audio-video data is stored, and a first wireless module. The first processor reads the audio-video data from the storage medium and multiplexes the audio-video data into a media stream by a peer-to-peer streaming protocol. The first wireless module transmits the media stream through the short-range wireless network.

The second mobile communication apparatus includes a second processor, a receiving end monitor, and a second wireless module. The second processor receives the media stream via the second wireless module from the short-range wireless network and de-multiplexes the media stream into audio-video data. Then, the second processor plays the de-multiplexed audio-video data on the receiving end monitor.

In this embodiment, the first mobile communication apparatus communicates with the second mobile communication apparatus by the 3G-324M protocol, such that the first mobile communication apparatus can communicate a video data encoding method and an audio data encoding method of the audio-video data to the second mobile communication apparatus. The second processor of the second mobile communication apparatus plays the audio-video data on the receiving end monitor according to the video data encoding method and the audio data encoding method of the audio-video data.

Further, the first mobile communication apparatus includes a transmitting end monitor. When the first processor of the first mobile communication apparatus reads the audio-video data from the storage medium, the first processor can play the audio-video data on the transmitting end monitor.

In brief, the invention achieves the goal of synchronously playing the audio-video data by a peer-to-peer streaming protocol (particularly, 3G-324M protocol) and a short-range wireless network. Therefore, the audio-video sharing according to the invention in a small area range (for example, in the same room) doesn't need a third system (as a server) to forward or transmit data, and thus the latency of data transmission can be reduced. Because the invention utilizes peer-to-peer short-range data transmission, high fees for using a 3G network are avoided and the users do not need to give or receive the audio-video data to/from each other by a medium of a memory card or a 3G network. And the users need not share or watch the video shown on the same cell phone, and then the further goal of real-time and synchronously sharing among handheld devices and its resulting entertainment property can be achieved. In other words, through the audio-video sharing method and audio-video sharing system of the invention, the audio-video data can be synchronously shared among several cell phones capable of communication in a 3G network.

The advantages and spirits of the invention may be understood by the following description together with the appended drawings.

### BRIEF DESCRIPTION OF THE APPENDED DRAWINGS

FIG. 1 illustrates a schematic diagram of an audio-video sharing system according to prior art.

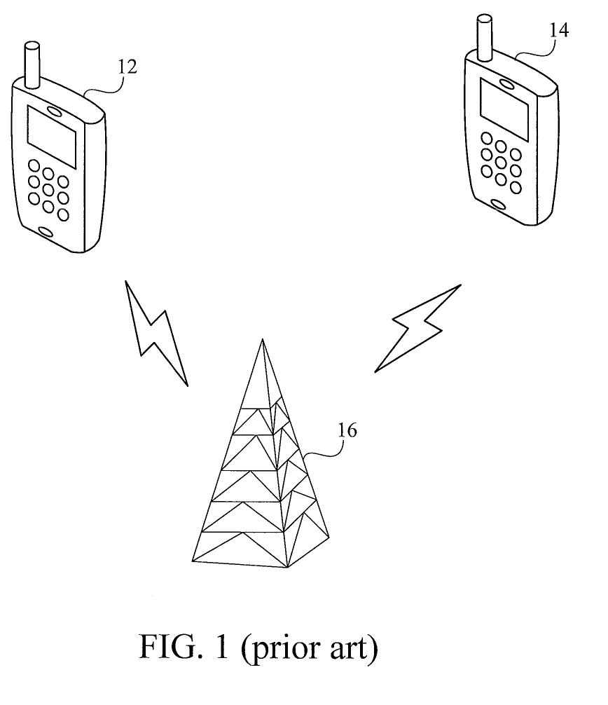

FIG. 2 illustrates an audio-video sharing system according to an embodiment of the invention.

FIG. 3 illustrates a flow chart of an audio-video sharing method utilized by the audio-video sharing system in FIG. 2.

FIG. 4 illustrates a schematic diagram corresponding to the step S10 in FIG. 3.

FIG. 5 illustrates a schematic diagram corresponding to the steps S13 and S14 in FIG. 3.

### DETAILED DESCRIPTION OF THE INVENTION

The audio-video sharing system of the invention includes a first mobile communication apparatus storing audio-video data and a second mobile communication apparatus.

It should be noted that the short-range wireless network can be wireless fidelity (Wi-Fi) network, Bluetooth network, ultra wide band (UWB) network, or infrared data association (IrDA) network, and the key is to have a short-range wireless network capable of peer-to-peer transmitting. Besides, the first mobile communication apparatus or the second mobile communication apparatus can be a small electronic apparatus with communication function, for example, a cell phone, a personal digital assistant (PDA), a mobile internet device (MID), or an ultra-mobile PC (UMPC). Further, the storage medium can be a read only memory (ROM), random access memory (RAM), or a flash memory. In order to make the detailed description below easier to read, the mobile communication is embodied by a cell phone, the short-range wireless network embodied by a Bluetooth network, and the storage medium embodied by a memory card (flash memory).

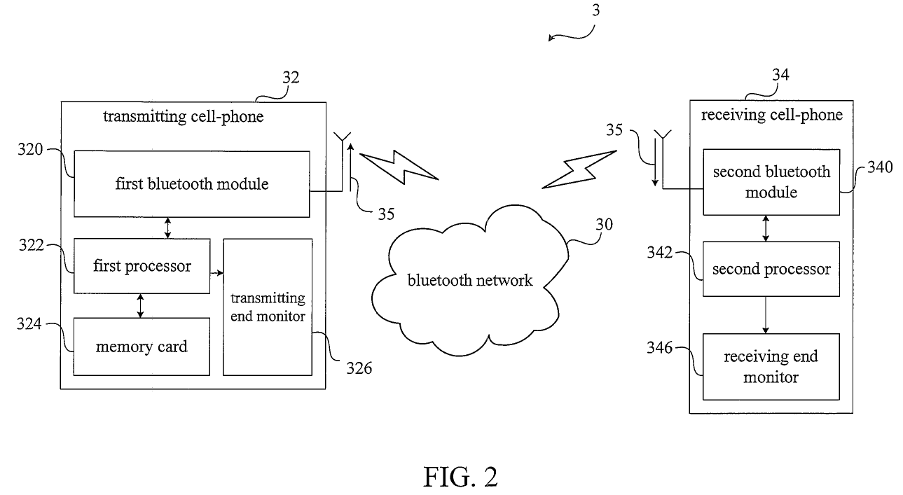

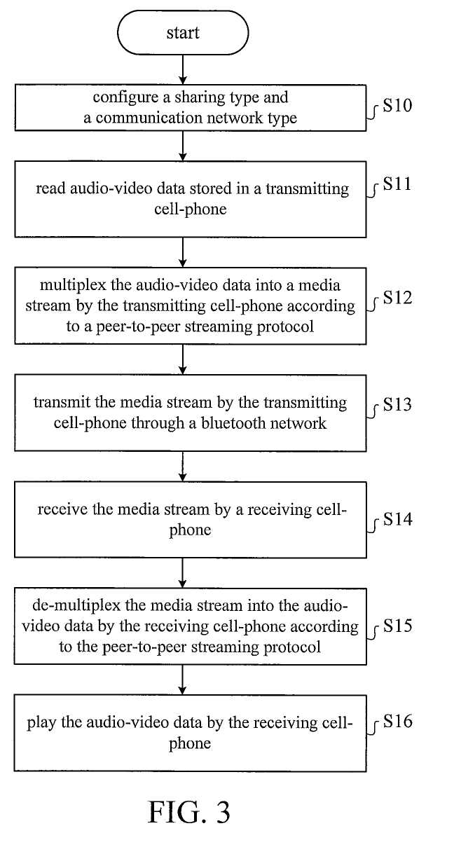

Please refer to FIG. 2 and FIG. 3. FIG. 2 illustrates an audio-video sharing system 3 according to an embodiment of the invention. FIG. 3 illustrates a flow chart of an audio-video sharing method utilized by the audio-video sharing system 3 in FIG. 2.

As shown in FIG. 2, the audio-video sharing system 3 of the invention includes a Bluetooth network 30, a transmitting cell phone 32, and a receiving cell phone 34. The transmitting cell phone 32 includes a first Bluetooth module 320, a first processor 322, a memory card 324, and a transmitting end monitor 326. The receiving cell phone 34 includes a second Bluetooth module 340, a second processor 342, and a receiving end monitor 346.

The audio-video data is/are stored in the memory card 324 of the transmitting cell phone 32. The first processor 322 of the transmitting cell phone 32 reads the audio-video data from the memory card 324, and multiplexes the audio-video data into a media stream 35 according to a peer-to-peer protocol. Then, the first processor 322 transmits the media stream 35 to the receiving cell phone 34 through the first Bluetooth module 320 and then the Bluctooth network 30. The second processor 342 of the receiving cell phone 34 receives the media stream 35 through the Bluetooth network 30 and the second Bluctooth module 340. Then, the second processor 342 de-multiplexes the media stream 35 into audio-video data and plays the de-multiplexed audio-video data on the receiving end monitor 346.

FIG. 3 illustrates the audio-video sharing between the transmitting cell phone 32 and the receiving cell phone 34 of the audio-video sharing system 3 in FIG. 2. The audio-video sharing method includes the following steps.

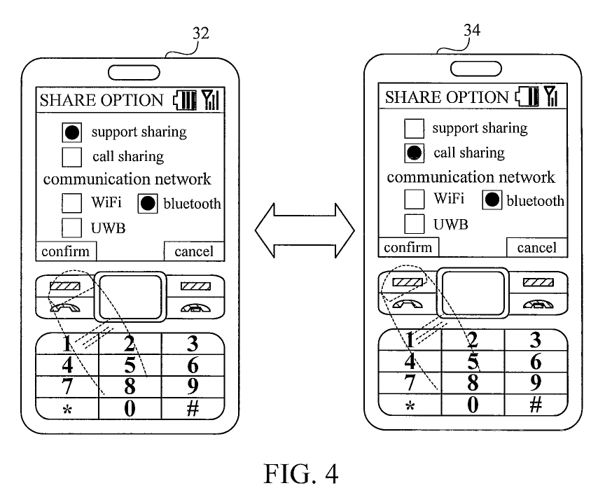

At first, configuration of the sharing type and communication network type of the transmitting cell phone 32 and the receiving cell phone 34 is performed in step S10, with the configuration illustrated in FIG. 4. The user can configure the sharing option of the transmitting cell phone 32 and the receiving cell phone 34 to be “supporting sharing” and “call sharing”, respectively. Therefore, when the audio-video sharing is performed among two cell phones, according to the configured sharing option, the cell phone which has the initiative of transmitting data can be determined. The cell phone with “call sharing” configuration is configured to receive shared data, and the cell phone with “supporting sharing” configuration is configured to transmit shared data.

As an additional note, the efficiency of power consumption or maximum allowable period of time for continuing usage is an important issue for small electronic apparatus such as a cell phone, and keeping additional wireless communication functions in an on state will consume much power. Therefore, it's more suitable or economical to turn on the wireless transmission (Bluetooth) function of the cell phone mainly when it's needed to share the audio-video data among cell phones.

Of course, the transmitting cell phone 32 and the receiving cell phone 34 both are configured under the same wireless transmission protocol, so as to communicate with each other. In this embodiment, both cell phones are configured under the same wireless transmission protocol “Bluetooth”. In general, if data is transferred between cell phones through the Bluetooth network, some steps such as searching for Bluetooth device and authenticating password need to be performed, and the step S10 can further include these related steps. For example, at first, these related configurations can be input by the user or set by the cell phone running particular software. Then, because these configurations have been set up, if the user wants to share the audio-video data by the cell phone, the cell phone can automatically complete the connecting procedures between cell phones to reduce the user operation complexity.

After the configuration of step S10, the user can choose particular audio-video data stored in the transmitting cell phone to be shared and play the audio-video data by the cell phone. So, reading the audio-video data from the memory card 324 by the first processor 322 of the transmitting cell phone 32 is performed in step S11. The audio-video data can be separated into video data and audio data, and the video data and the audio data respectively can be encoded by different encoding methods. Therefore, the first processor 322 has to respectively read the video data and the audio data according to the video data encoding method and the audio data encoding method, and thereby plays the audio-video data on the transmitting end monitor 326 (the LCD of the cell phone). For example, if the video data encoding method of the audio-video data is Xvid and the audio data encoding method is AC-3, the first processor 322 can decode the video data and the audio data by an Xvid codec and an AC-3 codec. Then, the decoded video can be played on the transmitting end monitor 326 and the decoded audio can be synchronously outputted by the transmitting end speaker (not shown).

When the transmitting cell phone 32 plays the audio-video data, the audio-video data can be synchronously shared. So, multiplexing the audio-video data into a media stream 35 by the transmitting cell phone 32 according to a peer-to-peer streaming protocol is performed in step S12. In this embodiment, the peer-to-peer streaming protocol is 3G-324M protocol. The purpose of multiplexing is to combine multiple data streams into a single media stream, and a data stream can comprise one or more of a video, audio, or control signal.

As an additional note, 3G-324M protocol is originally designed for the 3G network. Compared with the local area network (LAN) or the digital subscriber line (DSL), the bandwidth of a 3G network is smaller and the cost of network transmission is much higher. Therefore, before the processor multiplexes the audio-video data into the media stream, the audio-video data would be re-encoded according the video data encoding standard and the audio data encoding standard of the 3G-324M protocol, further to reduce the required bandwidth for transmission. In the 3G-324M protocol, the video data encoding method may be H.263, MPEG-4 or H.261 standard, and the audio data encoding method may be AMR (Adaptive Multi-Rate) standard (also called G.723 standard). According to the above-mentioned example for the step S11, the first processor 322 of the transmitting cell phone 32 re-encodes the video data to change the video data encoding method from Xvid to H.263 standard, and re-encodes the audio data to change the audio data encoding method from AC-3 to AMR standard. Then, the first processor 322 multiplexes the re-encoded video data and the re-encoded audio data into the media stream 35 according to H.223 standard of the 3G-324M protocol.

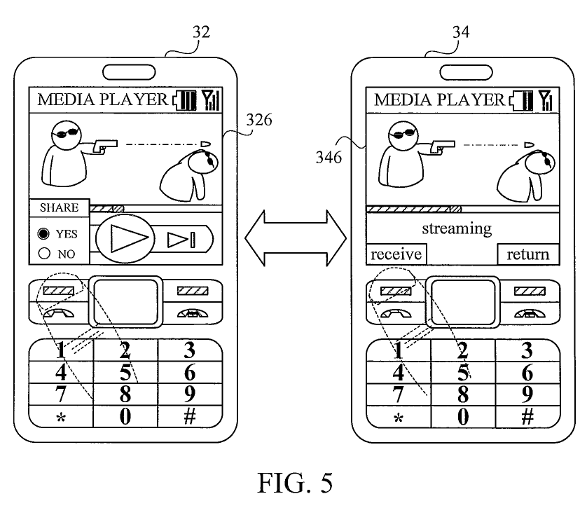

Then, transmitting the media stream 35 by the transmitting cell phone 32 through the Bluetooth network 30 is performed in step S13. As shown in FIG. 5, the user can set up the sharing configuration of the transmitting cell phone 32, such that the played audio-video data on the transmitting cell phone 32 can be synchronously shared with the receiving cell phone 34. In fact, before the transmitting cell phone 32 transmits the media stream 35, a logical channel has to be created in the Bluetooth network between the transmitting cell phone 32 and the receiving cell phone 34. The transmitting cell phone 32 then transmits the multiplexed media stream 35 to the receiving cell phone 34 through the logical channel.

It needs to be noted that, in the step S13, before the media stream is transmitted and after the logical channel is created, messages exchange should be performed between the transmitting cell phone 32 and the receiving cell phone 34 through a call control protocol. In 3G-324M protocol, the call control protocol is H.245 standard. The exchanged messages may concern multiplexing method, audio/video codec information, or the sharing type. For example, the receiving cell phone 34 can get a transmitting status of the media stream 35 through the call control protocol. Or the receiving cell phone 34 gets to know the original encoding method of the audio-video data through the call control protocol. Further, the receiving cell phone 34 can search itself to see if there is a corresponding codec before receiving the audio-video data. Thus the receiving cell phone 34 can be certain of whether it's able to successfully play the audio-video data before playing the audio-video data, thereby avoiding unnecessary audio-video data transmission that could have occurred when there is no corresponding codec in the receiving cell phone 34.

Then, receiving the media stream 35 by the second processor 342 of the receiving cell phone 34 via the second Bluetooth module 340 is performed in step S14. As shown in FIG. 5, the receiving setting of the receiving cell phone 34 can be configured for receiving the media stream 35. Compared with the prior art, the Bluetooth network 30 may have a characteristic of peer-to-peer transmission, so the receiving cell phone 34 can receive the media stream 35 without a [symbol] the) third system, and therefore unfavorable transmission latency of the media stream 35 can be reduced. 3G-324M protocol used together with the peer-to-peer wireless transmission is very suitable for audio-video applications with low tolerance to transmission latency, such as a video phone or audio-video synchronous playing (audio-video sharing). In addition, the 3G network system supplier sets up a server to enable two callers respectively at two locations to perform video communication with each other through the server, or to connect with the Internet via the server in order to browse the Web. Therefore, using the 3G network incurs additional fees of data transmission occurring through the server. But the peer-to-peer wireless transmission utilized by the invention doesn't incur these additional fees of data transmission occurring through the server. Besides, in order to share the audio-video data among several cell phones in a small area range, a short-range wireless network such as the Bluetooth network 30 is more suitable.

After receiving the media stream 35, de-multiplexing the media stream 35 into audio-video data by the second processor 342 of the receiving cell phone 34 according to the peer-to-peer streaming protocol (3G-324M protocol) is performed in step S15. The function of de-multiplexing is to de-combine the single media stream into multiple data streams, which can be handled by an electronic apparatus. In fact, in the step S15, the second processor 342 de-multiplexes the media stream 35 into a video stream and an audio stream according to the H.223 standard of the 3G-324M protocol.

At last, playing the de-multiplexed audio-video data on the receiving end monitor 346 by the second processor 342 of the receiving cell phone 34 is performed in step S16. In fact, in the step S15, the second processor 342 cannot directly play the de-multiplexed video stream and audio stream because these streams need to be decoded first. The second processor 342 respectively decodes the video stream and the audio stream through the corresponding codecs (video decoding method: Xvid, audio decoding method: AC-3). Then, the decoded video stream can be played on the receiving end monitor 346(the LCD of the receiving cell phone 34) and meanwhile the decoded audio stream can be played or outputted to the receiving end speaker (the speaker of the receiving cell phone 34).

As an additional note, in the step S16, compared with the frame displayed by the transmitting cell phone 32 playing the audio-video data, the frame is displayed with a latency time by the receiving cell phone 34 playing the de-multiplexed audio-video data, as shown in FIG. 5. The latency time is caused by the time for the data transmission. In the prior art, the audio-video data can be shared and played only after transmitting the whole audio-video file between the two cell phones, or giving or receiving the whole audio-video file through a medium of a memory card,. However the invention utilizes a short-range wireless network and peer-to-peer transmission, therefore the latency time is much shorter than that in the prior art. Therefore, the audio-video sharing system of the invention still has the characteristic of synchronously playing. In the embodiment of the invention, the audio-video data is shared by using a streaming method (playing audio-video data while the data transmission is still performed). Even if there is a short latency time between the two frames respectively displayed on the two cell phones, the users of the transmitting cell phone 32 and the receiving cell phone 34 can substantially synchronously watch the two frames of the original audio-video data respectively.

In addition, 3G-324M protocol originally is used in a circuit switching (CS) network. In general, the bandwidth of a single logical channel in a circuit switching 3G network is 64 Kbps. In order to reduce the latency time between frames shown on the transmitting cell phone 32 and the receiving cell phone 34 and satisfy the demand of the audio-video sharing, in this invention the bandwidth of the logical channel established in the short-range wireless network (such as the Bluetooth network 30) can be expanded to 128 Kbps or more, and thereby the invention can provide higher audio-video quality.

Besides, an advantage of using 3G-324M is that smaller bandwidth is required in using 3G-324M and 3G-324M provides sufficient audio-video quality. If any transmitted data is lost or data error occurs in the transmission of the media stream 35, the receiving cell phone 34 can readily supplement with the lost data or correct the data error according to 3G-324M protocol, such that the latency due to re-transmitting the lost data can be reduced.

Compared with the prior art, the invention achieves the goal of synchronously playing the audio-video data by a peer-to-peer streaming protocol (particularly, 3G-324M protocol) and a short-range wireless network. Therefore, the audio-video sharing according to the invention in a small area range (for example, both cell phones in the same room) doesn't need a third system (as a server) to forward or transmit data and thus the latency of data transmission can be reduced. And because the invention utilizes peer-to-peer short-range data transmission, high fees for using a 3G network are avoided and the users do not need to give or receive the audio-video data to/from each other by a medium of a memory card or a 3G network. And the users need not share or watch the video shown on the same cell phone, and then the farther goal of real-time and synchronously sharing among handheld devices and its resulting entertainment property can be achieved. In other words, through the audio-video sharing method and audio-video sharing system of the invention, the audio-video data can be synchronously shared among several cell phones capable of communication in a 3G network.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An audio-video sharing method for an audio-video sharing system, the audio-video sharing system comprising a short-range wireless network, a first mobile communication apparatus storing audio-video data, and a second mobile communication apparatus, the audio-video sharing method comprising the following steps of:
(a) the first mobile communication apparatus reading the audio-video data;
(b) the first mobile communication apparatus multiplexing the audio-video data into a media stream by a peer-to-peer streaming protocol;
(c) the first mobile communication apparatus transmitting the media stream through the short-range wireless network;
(d) the second mobile communication apparatus receiving the media stream;
(e) the second mobile communication apparatus de-multiplexing the media stream into audio-video data by the peer-to-peer streaming protocol; and
(f) the second mobile communication apparatus playing the de-multiplexed audio-video data.

2. The audio-video sharing method of claim 1, wherein the peer-to-peer streaming protocol is 3G-324M protocol.

3. The audio-video sharing method of claim 1, wherein the short-range wireless network is a wireless fidelity network, a Bluetooth network, or an ultra wide band network.

4. The audio-video sharing method of claim 1, wherein the step (b) comprises the following steps of:
(b1) the first mobile communication apparatus separating the audio-video data into video data and audio data; and
(b2) the first mobile communication apparatus multiplexing the video data and the audio data into the media stream by the peer-to-peer streaming protocol.

5. The audio-video sharing method of claim 4, wherein the step (e) comprises the following step of:
the second mobile communication apparatus de-multiplexing the media stream into video data and audio data of the audio-video data.

6. The audio-video sharing method of claim 5, wherein the step (f) comprises the following step of:
the second mobile communication apparatus synchronously playing the video data and the audio data.

7. An audio-video sharing system, comprising:
a short-range wireless network;
a first mobile communication apparatus comprising a first processor, a storage medium on which audio-video data is stored, and a first wireless module, the first processor reading the audio-video data from the storage medium, then the first processor multiplexing the audio-video data into a media stream by a peer-to-peer streaming protocol, and the first wireless module transmitting the media stream through the first wireless module and the short-range wireless network; and
a second mobile communication apparatus, comprising a second processor, a receiving end monitor, and a second wireless module, the second processor receiving the media stream via the second wireless module and the short-range wireless network, de-multiplexing the media stream into audio-video data, and playing the de-multiplexed audio-video data on the receiving end monitor.

8. The audio-video sharing system of claim 7, wherein the peer-to-peer streaming protocol is 3G-324M protocol.

9. The audio-video sharing system of claim 8, wherein the first mobile communication apparatus communicates with the second mobile communication apparatus by the 3G-324M protocol, to communicate a video data encoding method and an audio data encoding method of the audio-video data to the second mobile communication apparatus.

10. The audio-video sharing system of claim 9, wherein the second processor of the second mobile communication apparatus plays the de-multiplexed audio-video data on the receiving end monitor according to the video data encoding method and the audio data encoding method of the audio-video data.

11. The audio-video sharing system of claim 7, wherein the short-range wireless network is a wireless fidelity network, a Bluetooth network, or an ultra wide band network.

12. The audio-video sharing system of claim 7, wherein a bandwidth of the short-range wireless network is larger than or equal to 128 Kbps.

13. The audio-video sharing system of claim 7, wherein the first mobile communication apparatus comprises a transmitting end monitor, and when the first processor of the first mobile communication apparatus reads the audio-video data from the storage medium, the first processor plays the audio-video data on the transmitting end monitor.
